(19) United States
(12) Patent Application Publication
(10) Pub. No.: US 2015/0095253 A1
(43) Pub. Date: Apr. 2, 2015

(54) METHOD AND SYSTEM FOR CREATING A LIST OF ORGANIZATIONS BASED ON AN INDIVIDUAL'S PREFERENCES AND PERSONAL CHARACTERISTICS

(71) Applicant: Daniel Kibum Lim, Los Angeles, CA (US)

(72) Inventor: Daniel Kibum Lim, Los Angeles, CA (US)

(21) Appl. No.: 14/257,986

(22) Filed: Apr. 21, 2014

Related U.S. Application Data
(60) Provisional application No. 61/814,287, filed on Apr. 21, 2013.

(51) Int. Cl. G06Q 50/20; G06Q 10/00

(52) U.S. Cl. CPC G06Q 50/2053; G06Q 10/00
USPC 705/327

(57) ABSTRACT

A method and system for creating a customized and optimized application portfolio for educational institutions or other selective organizations. The system and method enables users to find a list of educational institutions or other selective organizations to which the user and/or a specified applicant may apply. The portfolio is composed accounting jointly for (1) to applicant attributes, preferences and constraints as well as (2) attributes of the institution or organization that accepts applications. According to certain embodiments, the portfolio is optimized to improve admission outcomes for the applicant and provide a customized set of matches between applicant and the institution or organization.

### CROSS-REFERENCE TO RELATED APPLICATIONS

This application claims the benefit of U.S. Provisional Application No. 61/814,287, entitled Method and System for Creating a Customized and Optimized Application Portfolio for Educational Objectives, filed on Apr. 21, 2013. The following U.S. patents and U.S. patent application publications are specifically incorporated herein by reference:

| | | |
|---|---|---|
| U.S. Pat. No. 6,003,018 | December 1999 | Michaud, et al. |
| U.S. Pat. Pub. 20020152151 | October 2002 | Baughman, et al. |
| U.S. Pat. No. 6,484,152 | November 2002 | Robinson |
| U.S. Pat. Pub. 20060069576 | March 2006 | Waldorf, et al. |
| U.S. Pat. No. 7,321,871 | January 2008 | Scott, et al. |
| U.S. Pat. No. 7,337,137 | February 2008 | Zosin, et al. |
| U.S. Pat. No. 7,340,425 | March 2008 | Boyle, et al. |
| U.S. Pat. No. 7,451,094 | November 2008 | Royall, Jr., et al. |
| U.S. Pat. No. 8,219,477 | July 2012 | Subbu, et a |

### TECHNICAL FIELD

The present invention relates to computer systems and methods for creating customized portfolios or educational institutions and other selective organizations.

### BACKGROUND OF THE INVENTION

Over the past few decades, admissions to educational institutions have steadily increased in difficulty, with institutions across the board reporting record high numbers of applicants and record low admission rates. Among students, one response to increased competition is to substantively improve themselves—more activities, better grades, higher test scores. Another response is to improve application presentation and strategy. This includes tasks such as polishing how accomplishments are presented in application materials, content and copy editing on application essays, and strategically choosing the number and composition of schools that comprise application portfolios. To the average applicant, each of these tasks presents a daunting challenge. As a result, many applicants seek external guidance to aid them in these tasks.

One source of outside help is third-party admissions websites. These websites typically offer two types of services. First, they may feature centralized repositories of official admission data that applicants would otherwise have to collect school-by-school for themselves. Second, many websites also boast proprietary databases containing data submitted by their own users who have gone through or are currently going through the admissions process. This proprietary data can be employed in at least two ways. First, they can be provided to users in raw or aggregate form as a supplement to official data that can answer questions that the latter cannot. Such data are typically presented in table form, sometimes accompanied by simple graphical plots which can be used to compare different schools (see U.S. News & World Report. “Best Colleges.”).

Proprietary data can also be used to make individual-level predictions about admission chance. Websites featuring this service take as input user information and output the user's chance of admission to particular colleges (see Parchment, Inc. “See My Chances.”). This is done through the use of statistical regression, used ubiquitously in fields as diverse as medicine, law, political science and psychology. These predictions can be helpful in selecting individual schools, since they employ sound statistical methods. However, they are insufficient for the task of constructing an entire application portfolio for at least three major reasons.

First, currently available methods do not analyze the entire portfolio of applications. Current methods can be helpful in recommending or giving information about single schools, but this is insufficient for the task of selecting an entire portfolio because the suitability of a particular school for a particular application portfolio depends on attributes of the overall portfolio (e.g. what other schools are also included in the portfolio). Second, currently available methods ask users to directly indicate the importance of pertinent factors, but it is well known that responses to such instruments suffer from problems that threaten the validity of collected responses—most notably, social desirability bias. Further, even if an individual is not privy to such biases, he may not actually know what he wants or how a particular preference fits into the bigger picture. As a result, tools that use such methods often recommend schools that do not fit the student's actual needs and desires. Finally, no current method of selecting schools provides a means for systematically weighting and comparing between the multitude of different factors relevant to the decision of whether or not to apply.

One method that is widely used to help selection of institutions to apply to is to provide raw or aggregate data and leave it to the user to parse through the data, decide what matters and select individual schools (see Parchment, Inc. “See My Chances.” Also see U.S. News & World Report. “Best Colleges.”). Another method that has been proposed is to help users select schools, one at a time, based on fit to personal characteristics or preferences (see US Patents 20060069576, Waldorf, et al.; U.S. Pat. No. 7,451,094, Royall, Jr., et al.; Also see Wisechoice.com. “How Wisechoice Works.”). However, for the reasons described above, no such method is satisfactory to optimally selecting an entire portfolio of schools to apply to.

Methods have also been proposed for the computer-assisted selection of portfolios of financial instruments (See U.S. Pat. No. 6,003,018, Michaud, et al.; 20020152151, Baughman, et al.; U.S. Pat. No. 6,484,152, Robinson; U.S. Pat. No. 7,321,871. Scott, et al.; U.S. Pat. No. 7,337,137, Zosin, et al.; U.S. Pat. No. 7,340,425, Boyle, et al.; U.S. Pat. No. 8,219,477. Subbu, et al.). These methods are suited to and intended solely for portfolios of financial instruments. Such methods are not suited to creating a portfolio of applications to educational institutions.

### SUMMARY OF THE INVENTION

A method and system for creating a customized and optimized application portfolio for educational institutions or other selective organizations. The system and method enables users to find a list of educational institutions or other selective organizations to which the user and/or a specified applicant may apply. The portfolio is composed accounting jointly for (1) to applicant attributes, preferences and constraints as well as (2) attributes of the institution or organization that accepts applications. According to certain embodiments, the portfolio is optimized to improve admission outcomes for the applicant and provide a customized set of matches between applicant and the institution or organization.

### DESCRIPTION OF THE DRAWINGS

FIG. 1 provides a conceptual diagram of an application portfolio according to certain embodiments of the invention.

FIG. 2 illustrates a distribution of admission probabilities, according to certain embodiments of the invention.

FIG. 3 illustrates the typical workflow experienced by users according to one embodiment of the invention.

FIG. 4 is a table of sources and categories of data used by certain optimization methods illustrated in FIG. 5

FIG. 5 is a block diagram illustrating an overall operation of the portfolio optimization method employed by one embodiment of the invention.

FIG. 6 illustrates one embodiment of a graphical user interface (GUI) used by users to modify and manage a plurality of application portfolios.

FIG. 7 illustrates one embodiment of an Internet form that is used to collect (1) the user preferences and (2) the weight of each preference that is used to valuate proposed portfolios in the optimization method illustrated in FIG. 5.

FIG. 8 is a block diagram illustrating the components comprising one embodiment of the application portfolio management system.

FIG. 9 illustrates components of a system within which the data, optimization methods, and user interface reside

### DETAILED DESCRIPTION OF THE INVENTION

The present invention provides a method and system for creating a customized and optimized application portfolio for educational objectives. In certain embodiments, the method and system enable users to find a list (i.e. application portfolio) of educational institutions to apply to. That list may be optimized to selected preferences and constraints that are particular to the user or other applicant as well as attributes of the educational institution that are relevant to an admissions process

The present description refers to a “user,” an “application portfolio” an “educational institution” and “optimization” methods. According to certain embodiments, the user may include an individual applicant to an educational institution. The user is also envisioned to include any operator of the system and methods, including but not limited to proxies, advisers, instructors and other operators. In some embodiments, the application portfolio may comprise a list of educational institutions, organizations, or other lists of objectives in which applicant attributes are used as a basis of selection. As noted, the present disclosure focuses upon “educational institutions” but other selective entities to which application is required or recommended are envisioned. Educational institutions include but are not limited to universities, colleges, training programs, secondary and primary schools, etc. and programs within these institutions including law schools, business schools, medical schools, graduate schools, etc. Other selective entities like organizations offering jobs, internships, apprenticeships, etc could be used in place of an “educational institution” for the system and method disclosed. The application portfolio can include any of these selective entities or combinations thereof. Optimization methods include a range of numeric and analytical methods commonly used or disclosed in this application as well as a variety of portfolio improvement methods that do not obtain a precise optimal result but merely a useful approximation.

This disclosure describes a method and system for enabling users to find a list (i.e. portfolio) of educational institutions (e.g. colleges, law schools, business schools, medical schools, graduate schools) to apply to that is optimized with respect to the user's admission chances and preferences regarding individual institutions and the overall portfolio. In certain embodiments, computer generated forms are used to obtain data from a user (or another applicant) that can be used to calculate the applicant's probabilities of admission to candidate institutions. Computer generated forms are also used to collect information on the user's preferences regarding individual institutions and the overall application portfolio. According to certain embodiments, a database of educational institutions and their characteristics as relevant to the admissions process is maintained. Using a subset of the data collected from the user in conjunction with data about a plurality of educational institutions, a plurality of candidate portfolios is generated. Using a subset of the data collected from the user, each institution in each candidate portfolio is evaluated for fit to the user's preferences, with each characteristic for each institution weighted according to the importance placed on each characteristic by the user.

Under certain embodiments, the user's probability of admission to each institution in each candidate portfolio is calculated, and the probabilities are used to generate a distribution of predicted probabilities for each portfolio. Each portfolio is assigned a single or plurality of objective values as function(s) of fit to the user's preferences. In one embodiment, this function is calculated from (1) an aggregate value of the fit values attributed to each institution in each portfolio; (2) the similarity between the admission probability distribution generated for each candidate portfolio and the distribution preferred by the user; and (3) the similarity between the portfolio's total application cost and the cost preferred by the user. A single-objective or multi-objective optimization/search algorithm is used to find the single or plurality of candidate portfolios with the best total value(s) attributed to each portfolio. In certain embodiments, a method and system for managing a plurality of application portfolios uses the selection method described above. In other embodiments, the selection method is designed according to alternative optimization techniques and entered into the system by the user or through an application program interface (API).

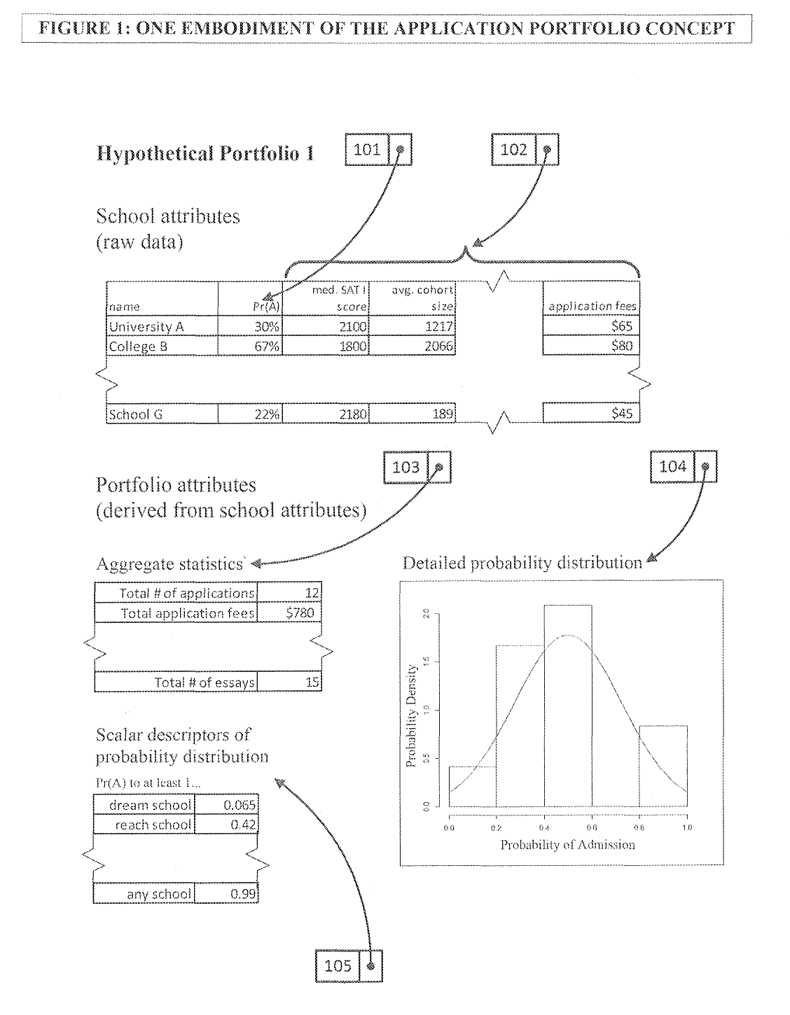

An application portfolio can be conceptualized, as in FIG. 1, as a list of schools to apply to, each of which is characterized by several attributes that are relevant to the process of admission. In one embodiment, the attributes that are analyzed are: the applicant's estimated probability of admission, Pr(A), to each school (101), and various summary statistics (102) describing academic, athletic, social, cultural, and financial characteristics of each school. In addition to the characteristics of each school in each portfolio, portfolios themselves can be conceptualized as possessing several characteristics that derive from the characteristics of the schools contained therein. In one embodiment, the examined portfolio-level characteristics include aggregate statistics about the portfolio (103), the distribution of acceptance probabilities attributed to each of the schools in the portfolio (104), and scalar descriptors (105) characterizing the probability distribution of the portfolio (104).

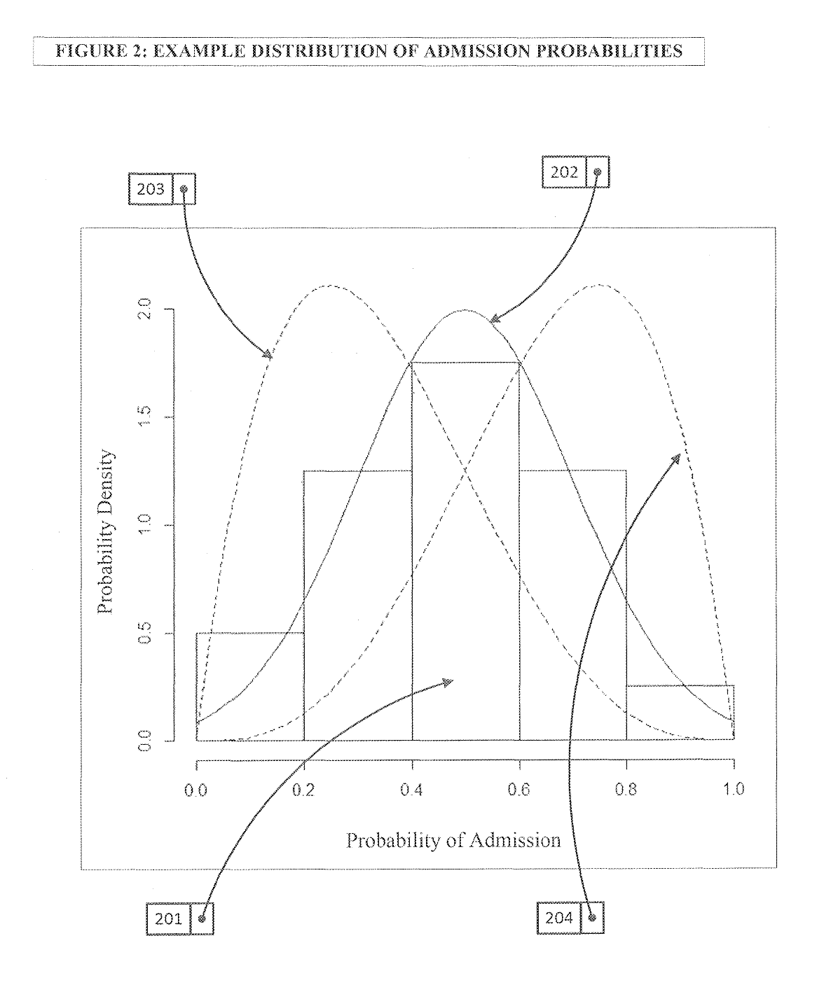

Another embodiment of item 104, the distribution of acceptance probabilities attributed to each of the schools in the portfolio, is shown in greater detail in FIG. 2. The bars in FIG. 2 (201) represent the frequency of schools to which the applicant has a probability of admission falling within a particular range. For example, the bar pointed to by item 201 indicates that for this particular portfolio, the density of schools with probability of admission between 0.4 and 0.6 is approximately 1.7. Further, the probability density can be characterized as a continuous distribution function (202). This conceptualization of the application portfolio is advantageous because probability densities can be characterized in a qualitative manner that can be understood by an individual with little to no statistical training. For example, a user who wishes to pursue an “aggressive” application strategy can be thought of as preferring a distribution with right skew (203). Similarly, a user wishing to pursue a “conservative” application strategy would be interpreted as expressing a preference for a portfolio with left distributional skew (204). The distribution represented by item 202 is approximately Gaussian in shape and would be considered a “balanced” application strategy. The qualitative description attributed to a particular distributional shape can vary from one embodiment to another. In certain embodiments, the qualitative descriptions of distributional forms may be fixed a priori. In certain embodiments, the qualitative descriptions of distributional forms may be defined by the user, to suit personal preferences.

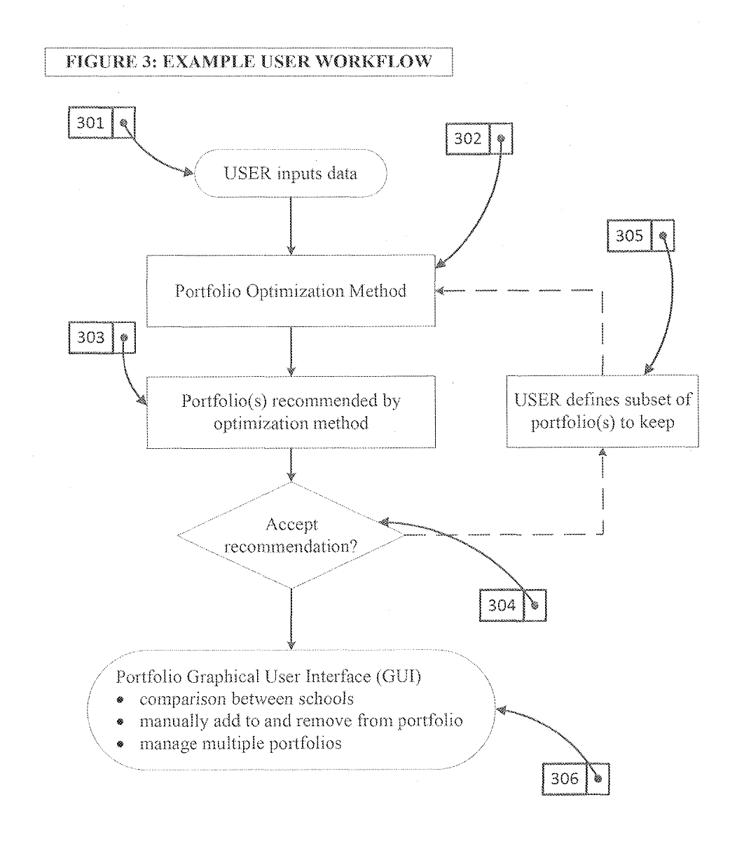

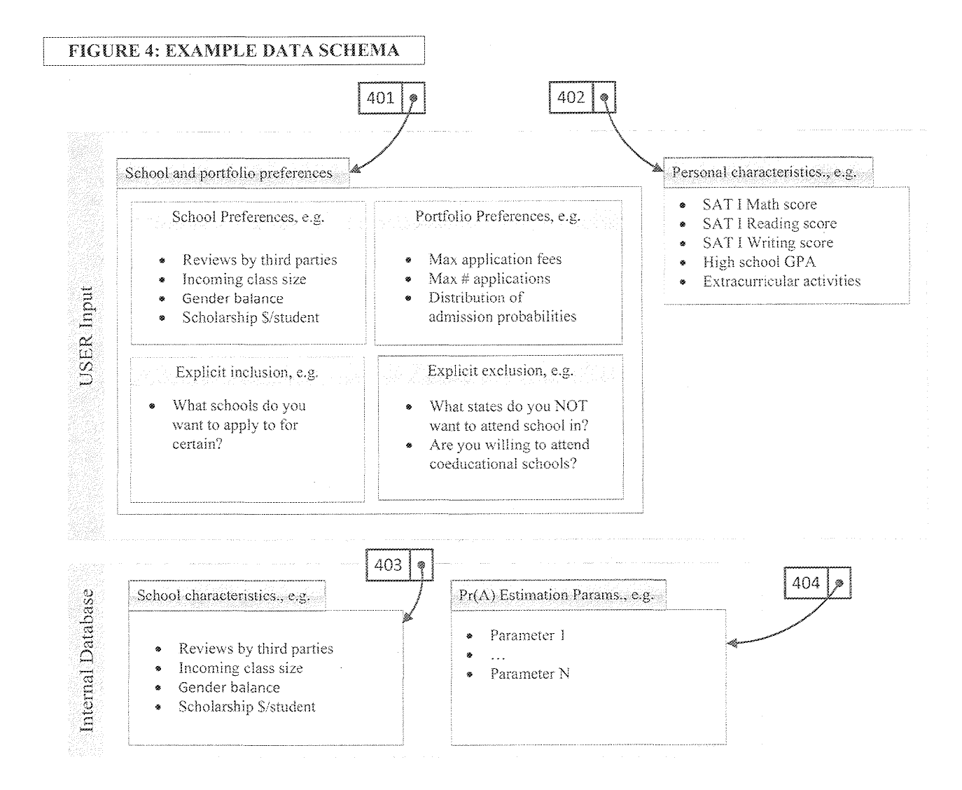

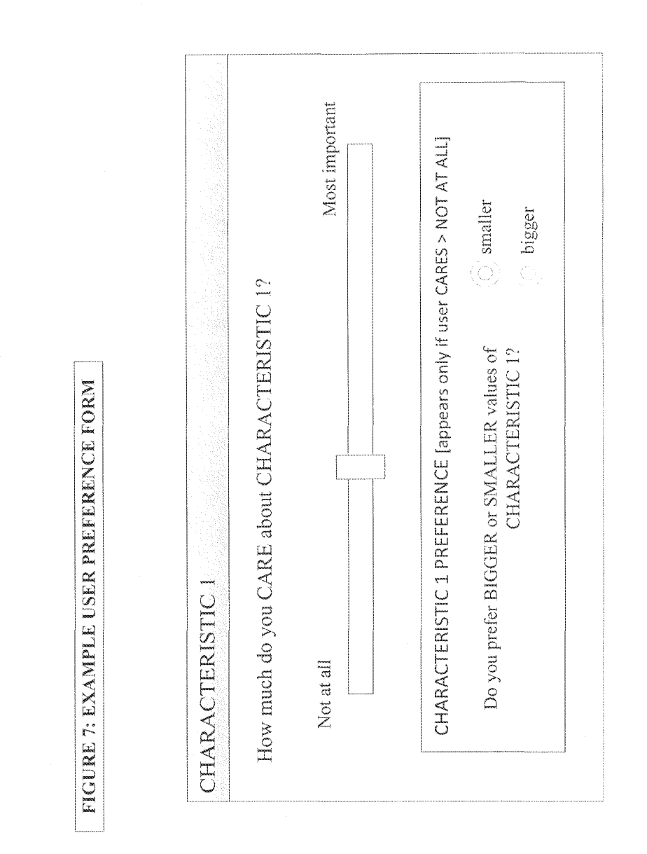

For the sake of illustration, the workflow experienced by a typical user of one embodiment will be elaborated on in detail throughout this description. This example workflow is illustrated in FIG. 3. The user begins by inputting a variety of data about his personal characteristics and preferences (301) or those of the prospective applicant he is assisting. The data is parsed and categorized according to a schema such as the one illustrated in FIG. 4. In that example schema, there are two major categories of data supplied by the user: school and portfolio preferences (401) and personal characteristics (402). The former is further divided into 4 subcategories. The first of these, school preferences, is information about what aspects of schools the user cares about (i.e. preference weights) and what his ideal value is for each of these aspects (i.e. preference values). As an example, in one embodiment, the user may indicate that he prefers schools where the ratio of women to men is 2:1 (the value) and that he cares “greatly” (the weight) about this aspect of schools. He may also indicate that he prefers “smaller” schools (the value) but he cares only a “little” (the weight) about this characteristic. The user is asked to supply values for all such value-weight pairs used by a given embodiment through the use of a series of computer form elements such as that pictured in FIG. 7.

The second subcategory of item 401 is portfolio preferences, which are attributes of the target portfolio that the user wishes to be recommended. In one embodiment, the user may, for example, specify that he wishes to only submit 8 application forms, spend no more than $600 on application fees and engage in an “aggressive” application strategy. These data points would constrain the allowable values of the portfolio-level characteristics described in items 103, 104, and 105, in turn constraining the portfolios that may result from using the method described here. These criteria may be supplemented by the last two data categories of item 401, explicit inclusion and exclusion criteria. For example, the user may specify that regardless of its interaction with other elements of his target application portfolio, he wishes to have a particular set of institutions included in the recommended portfolio(s). Likewise, he may choose to explicitly exclude institutions from certain geographies or possessing certain characteristics, rather than simply weighting them unfavorably.

Personal characteristics (402) comprise information that is used to predict Pr(A), the applicant's probability of admission to candidate institutions. One embodiment of this method would predict Pr(A) using the user's score on standardized tests, grade point average, and extracurricular activities. Another embodiment may additionally incorporate human assessments of admission probability, for example, made by educational consultants. Another embodiment may incorporate computerized or human assessments of the quality of application essays. Another embodiment may incorporate computerized or human assessments of the quality of recommendation letters that accompany the application.

With respect to the method of making the actual Pr(A) predictions, several well-known methods may be adapted to the present task. These methods typically involve using linear or nonlinear regression techniques to analyze existing empirical or simulated student data of the sort contained in item 402. Such analyses yield estimation parameters which are used with new incoming data to yield actual admission probability predictions. A number of such prediction methods are envisioned to process the data in item 402.

According to certain embodiments, the system maintains an internal database of pre-calculated estimation parameters (404) fir the prediction method(s) chosen to yield Pr(A) predictions. Estimation parameters may be specific to categories of educational institutions. For example, admission probabilities to one category of educational institutions may account heavily for standardized test scores or subsets thereof while other educational institutions may account heavily for quality of application essays. By way of illustration, engineering colleges that heavily weight SAT Math scores are assigned different pre-calculated estimation parameters than liberal arts colleges that heavily weight SAT Writing scores. Estimation parameters may be further adjusted to account for overlapping categories and portfolio combinations thereof.

According to another embodiment, the system dynamically estimates parameters for the prediction model based on data submitted by other users of the method. This dynamic prediction technique is performed by regressing admission outcome on user characteristics for a subset of available user data. As additional users input portfolio preferences and personal characteristics, admissions probability estimates are updated according to current competition information. Predictions for a particular individual applicant are made using the dynamically calculated model parameters. Yet another embodiment uses the statistical method of matching to match the user with similar users for whom the admission outcome is known. The user's Pr(A) may then be estimated as the ratio of admittees to rejectees among the similar other users.

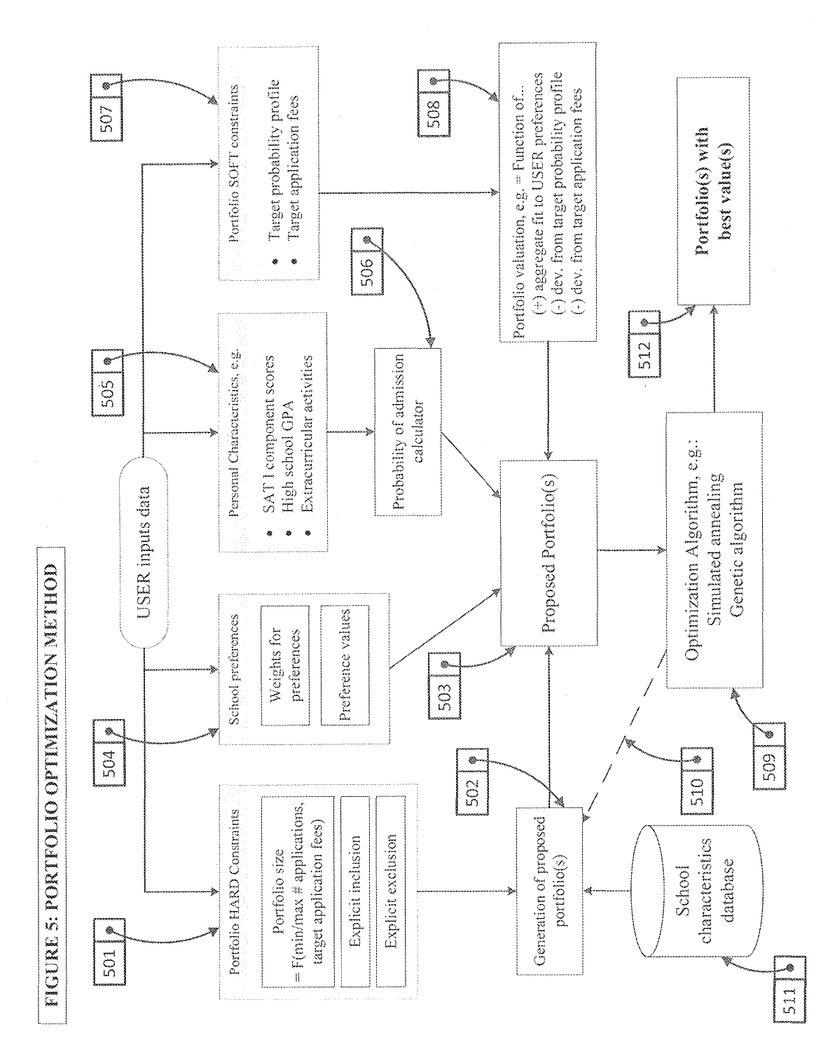

Returning to the user workflow in one embodiment of the invention, once the input data is parsed and categorized, it is fed into the portfolio optimization method (302), shown in greater detail in FIG. 5. The method begins by using a subset of the portfolio preferences from item 401, portfolio hard constraints (501), to generate a single or plurality of proposed (i.e. candidate) portfolios (503). Portfolio hard constraints are comprised of that subset of user preferences which define inviolable constraints on the number or character of schools that may be included in any portfolio acceptable to the user. As an example, the user may specify a maximum total application fee of $600 and a maximum 10 applications. Then, no portfolio with fees totaling greater than $600 or 10 total schools should be included in the set of candidate portfolios. The use of such constraints facilitates operation of the present method because it drastically reduces the size of the set of all possible portfolios which are searched to yield the optimal one(s). Information about the schools comprising each candidate portfolio is drawn from the invention's schools database (511), which may contain the types of data pictured in item 403.

Several different methods for generating candidate portfolios are envisioned and described by way of illustration. In one embodiment, the process of generating a candidate portfolio proceeds as follows. The user's maximum cost is used to estimate approximately how many institutions can be included in the portfolio for that cost. This number of schools may be estimated as the maximum cost specified by the user divided by the mean or median application fee of all the schools in the schools database. The number of institutions estimated from maximum cost is compared to the maximum number of institutions the user wishes to apply to. The lesser of those two numbers, N, is used as the actual number of institutions that will be included in the portfolio. A subset of all the schools in the schools database is drawn, where the subset includes all schools described by the user's explicit inclusion criteria (e.g. schools X and Y must be included, schools possessing characteristic Z must be included) and excludes schools based on the user's explicit exclusion criteria (e.g. schools in geography X must be excluded, schools Y and Z must be excluded). N schools are randomly drawn from the resulting subset. These N schools comprise a single candidate portfolio. This process may be repeated as many times as necessary contingent on the optimization method used.

In another embodiment, the process of generating a candidate portfolio may proceed as follows. The total number of schools in the portfolio, N, is estimated as described above. A subset of the schools in the schools database is drawn, also as described above. However, rather than draw schools at random from this subset, the user's probability of admission is estimated for each school that was drawn, and each school is placed in a bin based on its respective Pr(A). From each bin 13, N_{B} institutions are drawn, where N_{B} is the number of schools implied for bin B by the user's preferred application strategy. The probability distribution of the resulting portfolio will approximate that desired by the user, for example, by specifying the degree of “aggressive” or “conservative” application strategy desired. Again, this process may be repeated as many times as necessary contingent on the optimization method used.

Each of the schools in each of the portfolios yielded by an embodiment of item 502, such as those described above, is evaluated for similarity to the school preferences submitted by the user (504). This analysis may yield a scalar or vector of values characterizing fit to the user's preferences, where each scalar or vector is a function of 1) the difference between each school's value on a particular characteristic and the user's ideal value for that characteristic; and 2) the weight attributed to that characteristic by the user. In one embodiment, a vector of values characterizing fit may be generated as Pi−v̂Wi Vi where vi is the preference value for characteristic i and wj is the weight that the user wishes accorded to vj. In another embodiment, a scalar value may be used to characterize fit as Yii=oPi where N is the total number of characteristics that are measured.

Each of the schools in each of the portfolios yielded by item 502 is appended with a probability of admission for the user based on inputted personal characteristics (505) processed using a probability of admission calculator (506). This method was discussed in greater depth previously in this summary. The processes represented by items 504 and 505-506 need not occur sequentially, and may occur in any sequence or simultaneously.

Next, the present method ascribes a single or plurality of objective values to each candidate portfolio, which are the values that will be optimized with respect to. If a single objective value is ascribed to each portfolio, the method can be characterized as a single-objective optimization problem. If a plurality of objective values is ascribed to each portfolio, the method is characterized as a multi-objective optimization problem.

In an embodiment utilizing the single objective approach, calculation of a single objective value for a portfolio is conducted as follows: begin with a single aggregate statistic of the measure(s) of fit calculated earlier, such as the mean, median or sum. This scalar is the raw value of the portfolio. Adjust the raw value by a measure of fit between characteristics of the overall portfolio and the portfolio level preferences submitted by the user. This is the adjusted value of the portfolio.

Different methods of measuring fit to the user's portfolio level preferences are envisioned. One embodiment of the method begins by obtaining from the user their ideal values for various characteristics of the portfolio. These ideal values shall be referred to as portfolio soft constraints. The set of portfolio soft constraints may overlap with but not be identical to the set of portfolio hard constraints described earlier in the summary. An example of a constraint that can optionally be assigned as either a hard and/or a soft constraint is application fee. To illustrate: a user may specify their ideal total application fee as $600. Further, they may specify that $600 is an inviolable maximum. This information is a hard constraint because no portfolio can have a total application fee greater than $600. However, this information is also a soft constraint because, as an ideal point, portfolios with values below but further away from $600 should still be included but be penalized over values below and closer to $600. An example of a soft constraint that does not overlap with hard constraints is fit to target probability profile. Such portfolio preferences can only be soft constraints because few, if any, finite lists of schools will perfectly fit the expressed preferences. For example, a user may prefer a probability profile implying 3.1412 schools in a particular bin. No real portfolio can fit this preference perfectly, the best fit being offered by a portfolio with 3 schools in that bin. Thus, the value of 3.1412 is not a hard constraint but rather, an ideal point (i.e. soft constraint), which candidate portfolios should aspire to.

There are envisioned different means by which the raw value of the portfolio is adjusted using portfolio-level fit. In one embodiment, the plurality of portfolio-level measures of fit may be characterized by single a scalar statistic (e.g. mean, median, sum) characterizing the ratio of (1) the actual value of a portfolio-level characteristic to (2) the best possible value of that statistic, for all portfolio-level characteristics. For example, a portfolio may have actual cost $580, actual number of schools 10, ideal cost $600, and ideal number of schools 12. The two ratios in the aforementioned formulation may be 580/600 and 10/12, and the aggregate level statistic (e.g. mean) would be 0.9. So in this example, the raw value would be multiplied by 0.9 to yield the adjusted value. In another embodiment, deviations from the ideal values for each portfolio-level characteristic are arbitrarily weighted, then simply added to or subtracted from the raw value of each portfolio.

In embodiments where a plurality of objective values are to be ascribed to a portfolio, there are also envisioned multiple embodiments of the function that calculates those values. In one embodiment, the method begins by taking M clusters of the measure(s) of characteristic fit calculated earlier. The number of characteristic clusters, M, is an arbitrary number in the range 1 and N, the total number of characteristics considered for fit. Each of these clusters is characterized by an aggregate statistic applied to the values in the cluster, such as a mean, median or sum. These cluster statistics, in addition to measures of fit to the user's portfolio-level preferences, such as ideal application fee or ideal probability profile, comprise the multiple objectives to be optimized for using a multi-objective optimization method. In this scheme, the number of objectives equals M+P, where P is the number of portfolio-level characteristics used by the embodiment. In another embodiment, rather than optimize for school-level objectives as well as portfolio-level ones, the school-level objectives are all adjusted using a procedure similar to that for adjusting the raw value in the single objective formulation. For such embodiments, there results M total objectives.

Finally, the candidate portfolio(s) are fed into an optimization algorithm that seeks the portfolio with the best objective value(s) for the user. In embodiments utilizing a single-objective value for each portfolio, a single-objective optimization method, such as simulated annealing, a simple genetic algorithm, or particle swam optimization, may be used as the optimization method (509). These methods are described in Bertsimas and Tsitsiklis 1993, Goldberg 1989 and Engelbrecht 2005 and are herein incorporated by reference. In embodiments utilizing multiple objective values to characterize each portfolio, a multi-objective optimization method, such as the Strength Pareto Evolutionary Algorithm 2 (SPEA-2) or Nondominated Sorting Genetic Algorithm (NSGA-II), may be used. These methods are described in Zitzler et al. 2001 and Deb et al. 2002 and are herein incorporated by reference. Another embodiment uses a so-called interactive optimization method in which the user periodically provides feedback about the best solution(s) found thus far using one of the optimization methods mentioned above. For example, after several generations of executing a genetic algorithm, the user may be asked to rate some subset of the population of candidate portfolios, or mark one or more portfolios or schools for exclusion. The optimization procedure then resumes with the updated information on user preferences. Such an embodiment is illustrated in FIG. 3, where item 303 (also shown as item 512) is shown to the user, who then decides whether to accept the recommendations in part or whole (304). If he accepts the recommendations in part, he may choose which elements of the portfolio to keep (305), feed that information back into the method and continue the optimization process. Contingent on the needs of the optimization algorithm used, the method shall iteratively repeat (510) the steps shown in FIG. 5.

The final product yielded by item 509 is a single or plurality of portfolios (512) that approximate the best values for the user, given the information that he inputted. For embodiments using the single-objective approach, the result can be singular or plural because it is conceivable for multiple portfolios to share the same objective value, and because the family of optimization methods which are used approximate the optimal solution without necessarily finding the true best solution. For embodiments using the multi-objective approach, the portfolios that are recommended can be considered members of the Pareto set, which is the set of portfolios for which no characteristic of the schools or portfolio that is being optimized for can be improved without hurting the others.

Returning to the user workflow (FIG. 3), once the user chooses to keep the recommendations of system in whole, the optimization method is considered complete. The user may proceed to modify and manage the recommended portfolios or any portfolios he may have previously designed or had recommended to him (306).

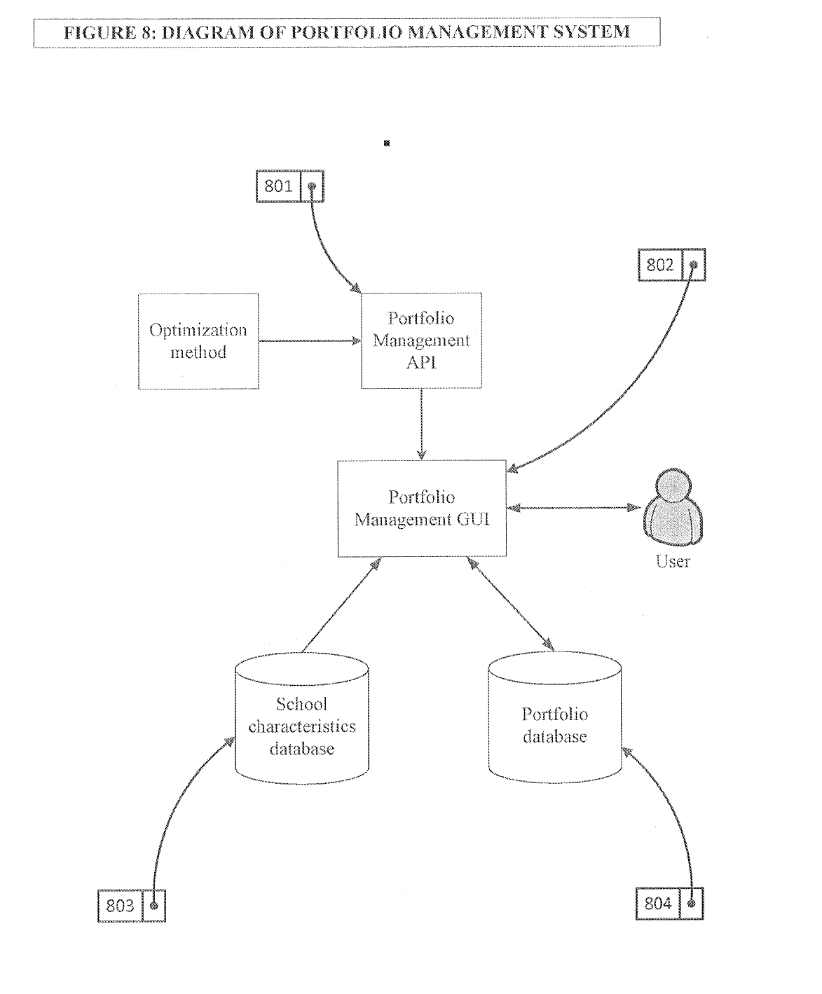

Certain embodiments include a system in which users may save, load, create, delete and otherwise manage a plurality of application portfolios. This system may be used both by persons who have used the portfolio optimization described thus far, as well as those who have not and wish solely to manage portfolios created through other means. There are four main components to this system, as seen in FIG. 8: a database which users may use to store portfolios to and retrieve portfolios from (804); a database of school characteristics which may be similar to that used by the optimization method described above (803); a graphical user interface (GUI) that can be used to accomplish various application portfolio management tasks (802); and an application program interface (API) through which the results of the above optimization method can be loaded directly into the management system (801).

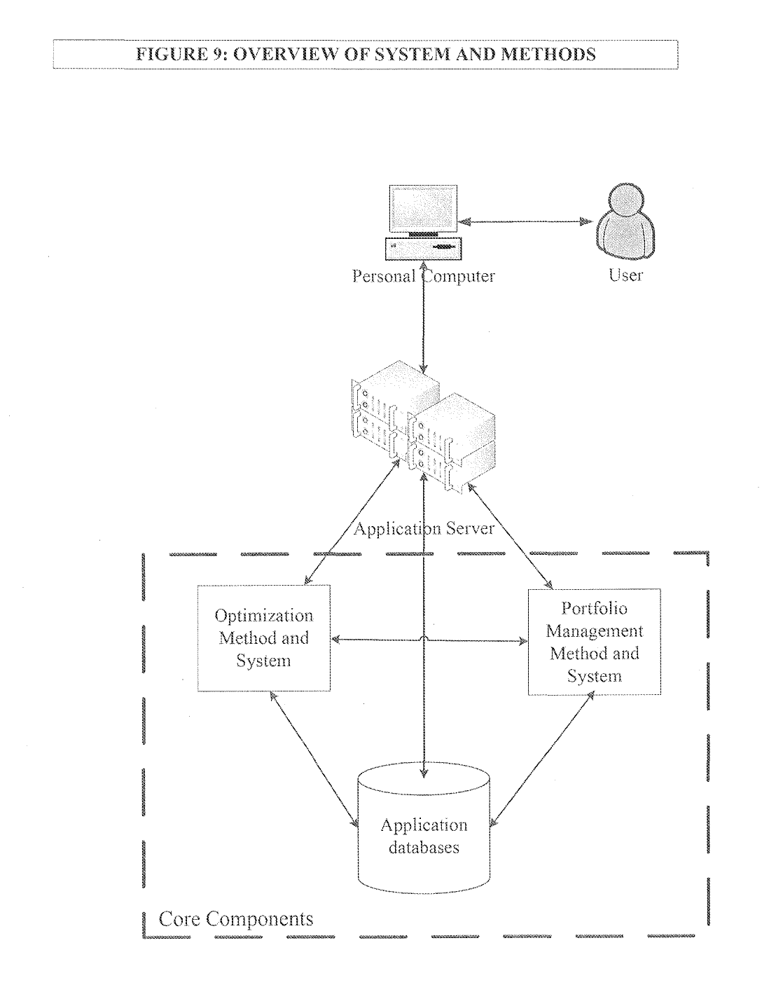

In order to save the current portfolio, or load or delete existing portfolios, a user may uniquely identify himself with the system using an authentication method such as a login ID and password. A user may modify an active portfolio using the management GUI. The management tasks which the user may accomplish include but are not limited to manually adding and removing schools from the active portfolio. In addition to management tasks, the user may use the management GUI to quickly and easily view information about his portfolio(s) and the schools therein, as well as any other school in the schools database. The accessibility of information afforded by the GUI aids the user in modifying the active portfolio to suit his preferences. The GUI enables the user to access the system through a personal computer, mobile device, etc. as shown in FIG. 9

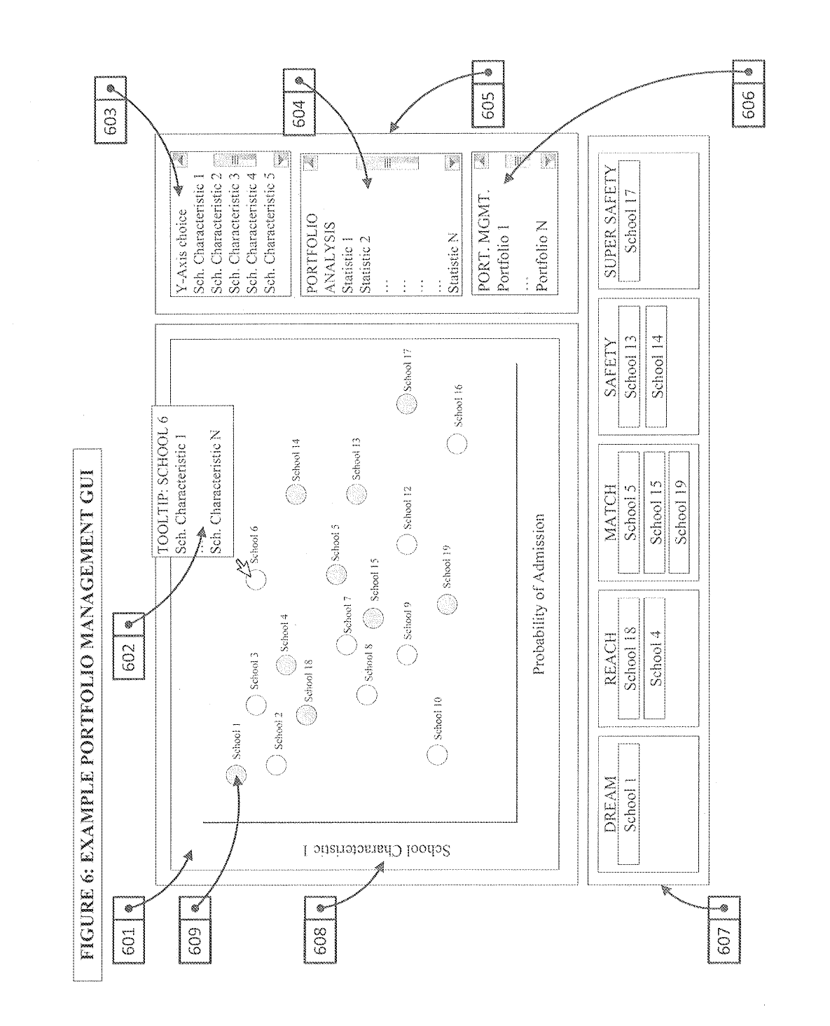

One embodiment of the portfolio management GUI is shown in FIG. 6. This example GUI contains 3 main elements: a plot panel (601), a controls and information panel (605), and a distributional information panel (607). The plot panel displays all of the schools in the portfolio as well as non-included schools from the schools database, each of which is represented by a circle (609) in the current embodiment. The schools are plotted with a characteristic of interest (e.g. admission rate, scholarship per student) on the Y-axis, and probability of admission for each school for the user on the X-axis. The values on the Y-axis may be controlled with the Y-axis control (603), the use of which causes the schools in the plot area to be reconfigured to reflect the appropriate Y-axis values. In this embodiment, the circles in the plot area change color to indicate whether associated schools are included in the portfolio or not. When a user places his mouse cursor over one of the circles, he activates a tooltip that shows a summary of information associated with that school. When he clicks on a circle, the associated school is added to or removed from the active portfolio, depending on whether it is currently in the active portfolio. The portfolio information panel (604) displays different portfolio characteristics (e.g. number of total applications, total application fees) and is updated dynamically as schools are added to and removed from the active portfolio. The portfolio save/load/delete panel (606) is used to save, load and delete portfolios. Finally, the distributional information panel (607) displays a discretized distribution of the schools in the active portfolio, categorized by school types commonly used in the educational consulting industry.

Educational institutions which the current invention can operate for include but are not limited to pre-college schools, undergraduate colleges, law schools, business schools, medical schools, graduate schools, art and/or design schools and culinary schools. Generally, sufficient information should be known about the institution to 1) estimate chances of admission tailored to individual users and 2) determine degree of similarity to the user's preferences. Adapting the present invention to suit it to a particular institution type does not require changes to any core component of the invention, rather, just loading the appropriate institutional data into the databases used by the systems and methods. It is also contemplated that the methods and system disclosed above may incorporate data on not only admittees to an educational institution but also attendees. Attendee information includes but is not limited to satisfaction information, financial information (e.g. post-graduation loans), employment information (e.g. employment during and after attending the educational institution), etc. These additional parameters can be used to create targeted application portfolios to optimize over long-term educational objectives.

The invention may be embodied in other specific forms without departing from the spirit or essential characteristics thereof. The present embodiments are therefore to be considered in respects as illustrative and not restrictive. It will be further appreciated that the scope of the present invention is not limited to the above-described embodiments, but rather is defined by the appended claims, and that these claims will encompass modifications of and improvements to what has been described.

1. A method, performed by a computer, for enabling users to find a list of educational institutions (AKA application portfolio) optimized for the user's circumstances as relevant to the process of admission to said institutions, the method being comprised of:
obtaining data from a user regarding their (1) preferences regarding individual institutions; (2) preferences regarding the overall list of institutions (i.e. application portfolio); and (3) probabilities of admission to candidate institutions as estimated from the user's personal characteristics
maintaining a database of educational institutions and their characteristics as relevant to the admissions process
using a subset of the data collected from the user in conjunction with the educational institutions database to generate a plurality of candidate portfolios
using a subset of the data collected from the user to valuate each institution in each candidate portfolio that was generated, said value being a function of (1) the similarity between each institution's value on a particular characteristic and the user's ideal value for that characteristic; and (2) the importance placed upon that characteristic by the user
using a subset of the data collected from the user to predict the user's probability of admission to each institution in each candidate portfolio that was generated, which is used to generate a distribution of predicted probabilities for each candidate portfolio
calculating a single or plurality of values for each candidate portfolio as function(s) of (1) an aggregate value of the fit values attributed to each school in each portfolio; (2) the similarity between the distribution generated for each candidate portfolio and the distribution preferred by the user as expressed data collected from them; and (3) the similarity between the portfolio's total application cost and the cost preferred by the user as expressed in the data collected from them
using a single-objective or multi-objective optimization/search algorithm, such as simulated annealing or a genetic algorithm, to find the single or plurality of candidate portfolios with the best total value(s) attributed to each portfolio

2. A method according to claim 1, for obtaining the required information from users to operate the method described in claim 1

3. A method according to claim 1, in which the set of potential candidate portfolios is constrained in number, composition and/or characteristic set to fit the preferences obtained from the user

4. A method according to claim 1, in which the weight placed upon each characteristic by a particular user is supplemented or wholly replaced by weights estimated through statistical analysis of empirical data provided by other users

5. A method according to claim 1, in which the predicted probabilities of admission are used to generate a scalar statistic, such as an overall probability of admission, in addition to or in place of a distribution of probabilities

6. A method according to claim 1, in which the single or plural values attributed to each candidate portfolio is additionally a function of the figures generated according to claim 5.

7. A method according to claim 1, in which the task of finding the best value(s) candidate portfolio(s) is accomplished through the use of so-called a posteori optimization methods including but not limited to NSGA-II, SPEA-2, and particle swarm optimization

8. A method according to claim 1, in which the task of finding the best value(s) candidate portfolio(s) is accomplished through the use of so-called interactive optimization methods in which the user is prompted to supply feedback about candidate portfolios at various stages of the optimization process

9. A method according to claim 1, in which the task of finding the best value(s) candidate portfolio(s) is accomplished through the use of a hybrid optimization method that is a combination of any of the optimization methods described in claim 1, claim 7 and claim 8.

10. A system according to claim 1 that is designed specifically to aid with finding optimal portfolios for applicants to undergraduate colleges.

11. A system according to claim 1 that is designed specifically to aid with finding optimal portfolios for applicants to law schools.

12. A system according to claim 1 that is designed specifically to aid with finding optimal portfolios for applicants to medical schools.

13. A system according to claim 1 that is designed specifically to aid with finding optimal portfolios for applicants to graduate schools.

14. A system according to claim 1 that is designed specifically to aid with finding optimal portfolios for applicants to business schools.

15. A system according to claim 1 that is designed specifically to aid with finding optimal portfolios for applicants to art and/or design schools.

16. A system according to claim 1 that is designed specifically to aid with finding optimal portfolios for applicants to culinary schools.

17. A system that may be used to save, load, create, delete and otherwise manage a plurality of application portfolios, the system being comprised of:
a database that users may store portfolios to and retrieve portfolios from
a database of educational institutions and their characteristics as relevant to the admissions process
a graphical user interface (GUI) through which users may create new portfolios
a graphical user interface (GUI) through which users may modify existing portfolios by adding schools to or removing schools from the active portfolio
a graphical user interface (GUI) through which users may save, load, and delete the portfolios that they have created, modified or loaded
a graphical user interface (GUI) through which users may graphically compare any set of arbitrary characteristics of the schools in the active portfolio with those of any arbitrary set of the schools for which information is contained in the database of educational institutions
an application program interface (API) through which the results of the method of claim 1 can be loaded directly into the present system

18. A system according to claim 17 that is designed specifically to aid in the management of portfolios for applicants to undergraduate colleges.

19. A system according to claim 17 that is designed specifically to aid in the management of portfolios for applicants to law schools.

20. A system according to claim 17 that is designed specifically to aid in the management of portfolios for applicants to medical schools.

21. A system according to claim 17 that is designed specifically to aid in the management of portfolios for applicants to graduate schools.

22. A system according to claim 17 that is designed specifically to aid in the management of portfolios for applicants to business schools.

23. A system according to claim 17 that is designed specifically to aid in the management of portfolios for applicants to art and/or design schools.

24. A system according to claim 17 that is designed specifically to aid in the management of portfolios for applicants to culinary schools.
Also, high schools and middle schools.
